(19) United States
(12) Patent Application Publication
(10) Pub. No.: US 2026/0249646 A1
(43) Pub. Date: Aug. 27, 2026

(54) WHEEL HEAD ASSEMBLY FOR A VEHICLE AXLE

(71) Applicant: ZF Friedrichshafen AG, Friedrichshafen (DE)

(72) Inventors: Julian Lüftl, Tiefenbach (DE); Andreas Acker, Meckenbeuren (DE); Karlheinz Hoher, Markdorf (DE)

(73) Assignee: ZF Friedrichshafen AG, Friedrichshafen (DE)

(21) Appl. No.: 19/551,994

(22) Filed: Feb. 27, 2026

(30) Foreign Application Priority Data
Feb. 27, 2025 (DE) 10 2025 107 441.0

(51) Int. Cl. B60B 27/00; B60B 27/02

(52) U.S. Cl. CPC B60B 27/0078; B60B 27/02

(57) ABSTRACT

A wheel head assembly for a vehicle axle includes an axle housing, a wheel hub, and a bearing unit. The bearing unit is arranged coaxially relative to an axial rotation axis, and the wheel hub is mounted by means of the bearing unit rotatably relative to the axle housing, and has at least two wheel bearings spaced apart in the axial direction. The bearing unit has first and second axial bearing unit ends. A first spacer element is arranged in the axial direction on the first bearing unit end and a second spacer element being arranged in the axial direction on the second bearing unit end. A fastening element is provided for axially fixing the bearing unit by securing the first and second spacer elements with the bearing unit.

### RELATED APPLICATIONS

This application claims the benefit of and right of priority under 35 U.S.C. § 119 to German Patent Application no. 10 2025 107 441.0, filed on 27 Feb. 2025, the contents of which are incorporated herein by reference in its entirety.

### FIELD OF THE DISCLOSURE

The invention relates to a wheel head assembly for a vehicle axle, the wheel head assembly comprising an axle housing, a wheel hub, and a bearing unit, wherein the bearing unit is arranged coaxially relative to an axial rotation axis, and wherein the wheel hub is mounted by means of the bearing unit so that it can rotate relative to the axle housing, wherein the bearing unit comprises at least two wheel bearings a distance apart from one another in an axial direction, and wherein the bearing unit has, respectively, an axial first bearing unit end and an axial second bearing unit end.

### BACKGROUND

Wheel heads for vehicle axles can be used together with drive modules, for example, in order to drive, steer, and brake vehicle wheels. For that purpose, the axle has at each end wheel heads which can be driven directly or indirectly and can be braked by an integrated brake. For that, the axle housing comprises at least one drive output shaft which transmits the drive torque and which is conventionally mounted by means of bearing units, in particular conical roller bearings.

The bearing units mounted on the axle housing require a lubricant in order to extend the life of the bearing units and to improve their functionality. However, the lubrication of the bearing units has to be repeated, since a single filling with lubricant is not sufficient for the entire useful life of the vehicle.

U.S. Pat. No. 12,005,734B2 discloses a wheel hub assembly with a hub body having an outer end section and an inner end section, a bearing assembly and a seal attached to the hub body, wherein the seal is arranged inside the bearing assembly.

The bearing assembly comprises an outer ring attached to the hub body, an inner ring and a plurality of bearings which enable the outer ring to rotate relative to the inner ring; wherein the inner ring comprises a flange section, a recess and an offset section inside the flange section; the seal comprises a seal housing and a sleeve, such that the hub body and the seal housing can rotate relative to the sleeve; the sleeve has a central opening for receiving a vehicle spindle and is configured in such manner that it forms a press fit with a sealing pin of the vehicle spindle; the sleeve has a contact section which extends in the recess and makes contact with the flange section of the inner ring; a stop of the bearing assembly comprises the flange section of the inner ring, wherein the stop is configured in such manner that it opposes a movement of the contact section of the sleeve in the recess of the inner ring in the direction of the outer end section of the hub body when the hub body, the bearing assembly and the seal together are displaced in an inward direction along the vehicle spindle; and the offset section of the inner ring has an outer diameter which is smaller than the outer diameter of the sealing pin of the vehicle spindle.

Such an assembly is used, for example, for a wheel head of utility vehicles designed for axles with the designations TP, FF, FL, TN and R according to SAE Standard J2475.

SAE Standard J2475 contains dimensions and tolerances for spindles in the interface range. The interface components include axle spindles, bearing cones, bearing spacers and seals. These dimensions and tolerances are provided for axles which are usually used in utility vehicles of categories 7 and 8.

For the lubrication of the bearings in such wheel hub assemblies, oil is predominantly used.

In contrast, in the European region wheel head assemblies lubricated with grease are often used, which have other dimensions.

Such, for example, as described in DE102017223349A1, is a bearing arrangement for a wheel head with a tire pressure regulation system, which comprises a first and a second bearing device for mounting a wheel hub, wherein the two bearing devices are arranged coaxially relative to a rotation axis; a spacer unit, which spacer unit is arranged in the axial direction between the first and the second bearing device so that the two bearing devices are kept a distance apart from one another by the spacer unit; a first sealing device for sealing the first bearing device and a second sealing device for sealing the second bearing device, the two sealing devices being arranged on the spacer unit, and wherein, between the two bearing devices in the axial direction relative to the rotation axis, a compressed-air space is delimited; wherein the spacer unit comprises a first spacer sleeve for receiving the first sealing device and a second spacer sleeve for receiving the second sealing device, the two spacer sleeves being made as separate components.

Likewise, DE 102017209462A1 shows a wheel head for the driven steered wheels of utility vehicles.

### SUMMARY

A purpose of the present invention is to provide a wheel head assembly which can be used in more ways.

This objective is achieved by a wheel head assembly with the features specified in claim 1. Advantageous designs emerge from the dependent claims, the description and the figures.

The objective is achieved by a wheel head assembly for a vehicle axle, the wheel head assembly comprising an axle housing, a wheel hub, and a bearing unit, wherein the bearing unit is arranged coaxially relative to an axial rotation axis and wherein the wheel hub is mounted by means of the bearing unit so that it can rotate relative to the axle housing, wherein the bearing unit comprises at least two wheel bearings a distance apart from one another in an axial direction, and wherein the bearing unit has, respectively, an axial first bearing unit end and an axial second bearing unit end, wherein a first spacer element and a second spacer element are fitted axially on the axle housing and wherein the first spacer element is arranged in the axial direction on the first bearing unit end and the second spacer element is arranged in the axial direction on the second bearing unit end, wherein a fastening element is provided for the axial fixing of the bearing unit, in particular for the axial securing of the first and second spacer elements with the bearing unit and the axle housing.

In particular, the spacer elements are arranged on or fixed to the axle housing.

In particular, in that way, a hollow space formed, which is delimited by the two wheel bearings and the wheel hub.

In this case, the first bearing unit end faces in the direction of the wheel head and the second bearing unit end is axially opposite it.

Spacer elements are for example spacer rings or ring-shaped elements which rest, directly or indirectly, with their inner side in contact with the outside of the axle housing. Thanks to such spacer elements the operation of the wheel head or wheel head assembly is not interfered with.

In the context of the invention, it has been recognized that a previous 1:1 exchange of a wheel head, for example one lubricated with grease, cannot be carried out with the wheel head of utility vehicles designed for axles with the designations TP, FF, FL, TN and R according to the SAE Standard J2475.

According to the invention, two spacer elements, in this case for example spacer rings, which rest against the axle housing along their inside circumference, are arranged axially on the axle housing. In addition, a fastening element is provided for the axial fixing, for example securing of the entire bearing unit, in particular securing the first and second spacer elements with the entire bearing unit in the wheel hub. With appropriate seals this provides a hollow space that can contain lubricating grease for lubricating the wheel bearing. In that space, for example lubricating grease even in the form of a sufficient quantity of oil can be provided, as is usual for the wheel head in accordance with the SAE Standard J2475 Type R spindle.

By virtue of the variably designed spacer elements, the wheel head assembly can be adapted for various different machines so that such a wheel head assembly can be used in many ways. Thus, for example, thanks to the invention a wheel head assembly for a wheel head is indicated, which is appropriate for the SAE Standard J2475 Type R spindle. In that way compatibility of a grease-lubricated wheel head with the SAE Standard is achieved, whereby the possible applications are extended.

By virtue of such a wheel head assembly according to the invention, a simple and cost-effective solution can also be provided.

As a further development, the fastening element is arranged on the axle housing in the axial direction, in particular axially adjacent to the first spacer element, i.e., the spacer element which faces outward in the direction of the wheel head/the wheel to be attached. Thus, the bearing unit can easily be fixed with the two spacer elements onto the axle housing. In that case, the second spacer element is arranged between the second bearing unit end and the axle housing.

Then, the two spacer elements and the bearing unit are pressed onto the axle housing, or are secured by means of the fastening element.

In particular, the two spacer elements and the bearing unit are arranged in a bore of the wheel hub. In particular, the fastening element comprises at least one nut, if necessary, with thrust washers arranged in the bore of the wheel hub with the two spacer elements, and the bearing unit. In that way, the bearing unit, the spacer elements and the nut can be arranged in the wheel hub in a simple manner. Accordingly, there is no need for complicated modifications.

As a further development, the first spacer element and the second spacer element are in the form of a first spacer ring and a second spacer ring, for example a sleeve. These can be made easily and attached to the axle housing.

In particular the second spacer ring is arranged between the axle housing and the bearing unit. By virtue of the fastening element and the bearing unit and the first and second spacer rings, axial fixing with the wheel hub and the axle housing takes place.

Likewise, preferably the second spacer ring is secured axially by the axial fastening element between the second bearing unit end and the axle housing. In that way the bearing unit with the spacer elements, in this case the spacer rings, are firmly secured between the fastening element and the axle housing.

As a further development, a first sealing ring and a second sealing ring, for example in the form of shaft sealing rings are provided, wherein the first sealing ring is arranged radially between the first bearing unit end and the wheel hub, and the second sealing ring is arranged between the second bearing unit end and the wheel hub. In that way, the hollow space formed between the wheel bearings of the wheel hub can be filled with oil as a lubricant, which extends the application range of such a wheel head assembly. In this context the term sealing ring can also include a seal.

In an embodiment, the bearing unit can be in the form of a compact bearing. Such so-termed compact bearings can consist of an undivided outer ring, two inner rings, roller bodies, and a cage. They can, for example, be pre-greased, sealed, and maintenance-free, and accordingly simple to fit. For example, the compact bearing can also be designed to be used in a wheel head of utility vehicles designed for axles designated as TP, FF, FL, TN and R according to the SAE Standard J2475.

As a further development, a first sealing ring and a second sealing ring (shaft sealing rings) are provided, wherein the first sealing ring is arranged between the first spacer element, in this case the first spacer ring, and the wheel hub, and the second sealing ring is arranged between the second spacer element, in this case the second spacer ring, and the wheel hub.

In that case, the first and second spacer elements can comprise a (static) seal that extends in the direction of the axle housing for sealing the spacer element relative to the axle housing. The two spacer elements are accordingly at the same time seal carriers. Thus, the two spacer elements each form a counter-running surface for a dynamic seal and are at the same time carriers of a static seal.

As a further development, the first and second spacer elements, in this case the first and second spacer rings, can have, respectively, a first receiving feature and a second receiving feature for receiving the first and second sealing rings. That feature can be, for example, an all-round groove into which the respective sealing ring fits.

As a further development, the two axially separated wheel bearings can be connected by a spacer sleeve. In that case, the spacer sleeve is designed to receive the axle housing and also a (flanged) shaft. The spacer sleeve, for example its inside circumference or inner side, is arranged on the axle housing. Thus, the two wheel bearings, the spacer sleeve, and the wheel hub together form the hollow space which, for example, in the North American market, is filled with oil, but in the context of this invention should be used for filling with grease.

By virtue of such a spacer sleeve with the spacer elements, high variability is achieved, particularly as regards the size of the hollow space.

As a further development, the two spacer elements can each have an axial spacer element width such that the two spacer element widths can be made different. Depending on the design of the wheel head assembly the spacer elements can also differ radially. In that way further high variability can also be achieved.

### BRIEF DESCRIPTION OF THE DRAWINGS

Further properties and advantages of the present invention emerge from the following description, with reference to the attached figures, which show:

FIG. 1: A wheel head assembly viewed in section, according to the prior art in the European market,

FIG. 2: A first design of a wheel head assembly according to the invention,

FIG. 3: A second design of a wheel head assembly according to the invention.

### DETAILED DESCRIPTION

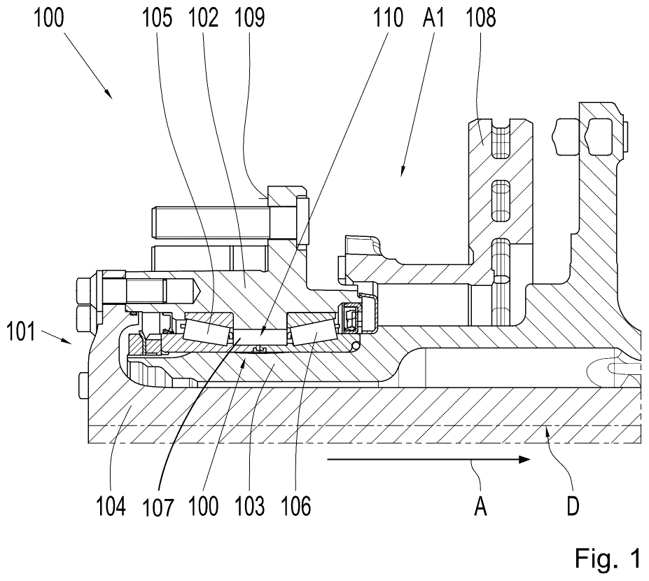

FIG. 1 shows a sectioned view of a wheel head assembly 100 according to the prior art for a vehicle. For example, the vehicle is a utility vehicle such as an agricultural machine or a truck. In this case, the wheel head assembly 100 comprises a wheel head 101, a wheel hub 102, and an axle housing 103, wherein the wheel hub 102 is mounted on the axle housing 103 and can rotate relative to an axial direction A.

In addition, a shaft is provided, in particular a flanged shaft 104. The axle housing 103 is at least partially designed to receive the flanged shaft 104 relative to an axial direction A. The wheel hub 102 serves to receive a vehicle wheel of the vehicle, wherein the vehicle wheel is for example held rotationally fixed onto the wheel hub 102 by a screw connection. The wheel hub 102 and the axle housing 103 are arranged coaxially with one another relative to a rotation axis D. During a journey of the vehicle, the wheel hub 102 rotates around the rotation axis D whereas the axle housing 103 remains static.

For example, the wheel hub 102 with its rotation axis defines the rotation axis D.

The wheel head 101 can be part of a vehicle axle, wherein the vehicle axle can for example be in the form of a steered and/or a driven vehicle axle of the vehicle. In particular, the axle housing 103 is connected to the vehicle body.

The wheel hub 102 is mounted rotatably relative to the axle housing 103 by means of a bearing unit 110 and can rotate about the rotation axis D.

In this case, the bearing unit 110 comprises at least two wheel bearings 105, 106 spaced a distance apart from one another in the axial direction A, which here contain two individual conical roller bearings. The two wheel bearings 105, 106 serve for the axial and/or radial mounting of the wheel hub 102.

A hollow space 107 is delimited in the radial direction relative to the rotation axis D, on the one hand by the inside circumference of the wheel hub 102 and on the other hand by the bearing unit 110, the hollow space 107 being filled, for example, with lubricating grease.

Furthermore, a brake disk 108 is provided, as well as a wheel rim surface 109, these two being a distance Al apart.

Previously, with such a wheel head assembly 100 there was no compatibility between grease-lubricated wheel heads 101 and a wheel head of utility vehicles designed for axles designated TP, FF, FL, TN and R in accordance with SAE Standard J2475. In this case, the SAE Standard J2475 contains dimensions and tolerances for spindles in the interface range. The interface components include axle spindles, bearing cones, bearing spacers, and seals. These dimensions and tolerances are provided for axles which are usually used for utility vehicles of categories 7 and 8.

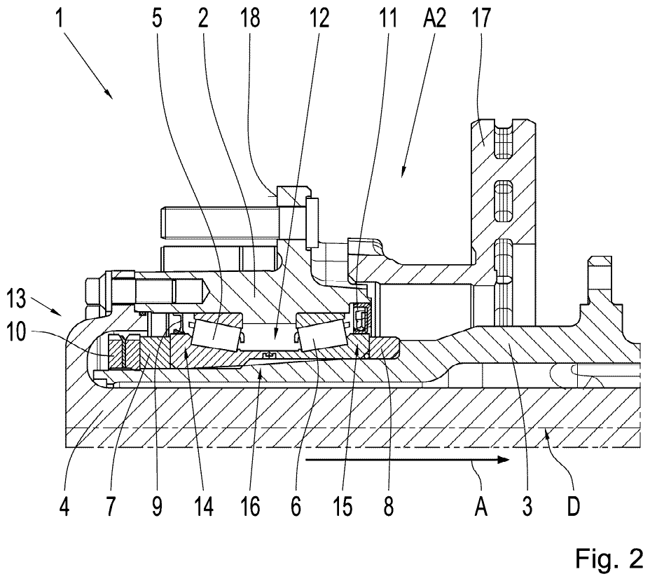

FIG. 2 shows a first design of a wheel head assembly 1 according to the invention. This also comprises a wheel head 13, a wheel hub 2, and an axle housing 3, wherein the wheel hub 2 is mounted onto or on the axle housing 3. Furthermore, a shaft, in particular a flanged shaft 4, is provided. The axle housing 3 is designed at least partially for receiving the flanged shaft 4 relative to an axial direction A. The wheel hub 2 serves to receive a vehicle wheel of the vehicle. The wheel hub 2 and the axle housing 3 are arranged coaxially and/or concentrically with one another, again relative to a rotation axis D. During a journey of the vehicle the wheel hub 2 rotates about the rotation axis D while the axle housing 3 remains stationary.

The wheel hub 2 is mounted rotatably relative to the axle housing 3 by means of a bearing unit, in this case designed as a compact bearing 16, and can rotate about the rotation axis D. Here, the compact bearing 16 comprises at least two wheel bearings, namely, a first and a second wheel bearing 5, 6 spaced an axial distance apart from one another. Such so-termed compact bearings 16 can consist of an undivided outer ring, two inner rings, roller bodies, and a cage, the latter forming the wheel bearings 5, 6. Such compact bearings 16 can be, for example, pre-greased and maintenance-free, and therefore are simple to fit.

The compact bearing 16 is designed to enable the axial and/or radial mounting of the wheel hub 2.

Furthermore, the compact bearing 16 (as a whole) comprises in each case an axial first bearing unit end 14 and an axial second bearing unit end 15.

The first axial bearing unit end 14 faces toward the wheel to be fitted, while the second axial bearing unit end 15 is arranged opposite it. In addition, a first and a second spacer element, here in the form of spacer rings 7, 8, are provided in order to be attached axially. The first and second spacer rings 7, 8 can have equal axial widths or different axial widths. The first and second spacer rings 7, 8 are fitted on the axle housing 3 in the axial direction A. The first spacer ring 7 is fitted in the axial direction onto the first bearing unit end 14, in this case in the direction of the wheel to be fitted, and the second spacer ring 8 is fitted in the axial direction A onto the second bearing unit end 15.

Thus, the second spacer ring 8 rests on the one hand against the axle housing 3 and on the other hand against the second bearing unit end 15. This can be a direct contact or an indirect contact, for example via an intermediate element.

The first spacer ring 7 rests against the first bearing unit end 14. Furthermore, a fastening element, in this case a nut 10 is provided. This is fitted onto the axle housing 3 (before the first spacer ring 7). By means of the nut 10 the first spacer ring 7, the compact bearing 16 and the second spacer ring 8 can be secured in the wheel hub 2 with the axle housing 3 by being pressed against the axle housing 3. For that, the first spacer ring 7, the compact bearing 16, and the second spacer ring 8 are arranged in a bore in the wheel hub 2 and pressed against the axle housing 3 by the nut 10.

The nut 10 serves to fix the compact bearing 16, in particular to secure the first and second spacer rings 7, 8 against the compact bearing 16.

Likewise, between the wheel hub 2 and the first bearing unit end 14 and the second bearing unit end 15, a first shaft sealing ring 9 and a second shaft sealing ring 11 are arranged, in each case radially, in order to seal the compact bearing 16. This means that the shaft sealing rings 9, 11 are secured for example between the wheel hub 2 and the respective bearing unit ends 14, 15.

By virtue of such a design, a hollow space 12 is produced between the two wheel bearings 5, 6, which space is delimited radially by the wheel hub 2 or its inside. Thanks to this arrangement the hollow space 12 can be filled with lubricating grease or even with oil.

In addition, a brake disk 17 is provided, and a wheel rim contact surface 18, which are a distance A2 apart, the distance A2 being smaller than the distance Al such that the assemblies so designed can be used for a wheel head 13 of utility vehicles designed for axles designated TP, FF, FL, TN and R according to the prior art in North America. Here, the distance A2 corresponds to a distance specified in the SAE Standard J2475.

By virtue of the wheel head assembly 1 and the adaptation of the wheel mounting system a 1:1 exchange between oil-lubricated and grease-lubricated wheel heads is possible. Thus, for example, all the interfaces and relevant dimensions identical to those in the SAE Standard J2475 are possible.

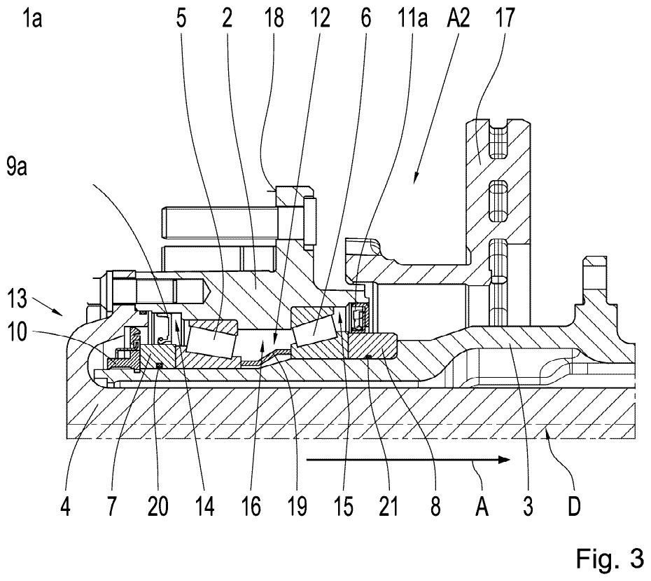

FIG. 3 shows another design of a wheel head assembly la according to the invention. This also comprises a wheel head 13, a wheel hub 2, and an axle housing 3, wherein the wheel hub 2 is mounted, rotatably relative to an axial direction A, onto or on the axle housing 3. In addition, a shaft, in particular a flanged shaft 4, is provided. The axle housing 3 is designed at least partially to receive the flanged shaft 4 relative to an axial direction A. The wheel hub 2 serves to receive a vehicle wheel of the vehicle. The wheel hub 2 and the axle housing 3 are again arranged coaxially and/or concentrically with one another relative to a rotation axis D. During a journey of the vehicle the wheel hub 2 rotates about the rotation axis D, whereas the axle housing 3 remains stationary.

The wheel hub 2 is mounted rotatably relative to the axle housing 3 by virtue of a bearing unit, and can rotate about the rotation axis D.

Furthermore, again, a first and a second spacer element, here in the form of spacer rings 7, 8, are provided in order to be fitted axially. The first and second spacer rings 7, 8 are fitted onto the axle housing 3 in the axial direction A. The first spacer ring 7 is fitted in the axial direction onto the first bearing unit end 14, in this case in the direction toward the wheel to be fitted, and the second spacer ring 8 is fitted in the axial direction onto the second bearing unit end 15.

The bearing unit comprises at least two wheel bearings 5, 6 spaced a distance apart from one another in the axial direction. The two axially separated wheel bearings 5, 6 are connected by a spacer sleeve 19. The spacer sleeve 19 is designed to receive the axle housing 3 and also the shaft 4. The spacer sleeve 19 can be adapted to the geometrical shape of the axle housing 3, for example having a kink. The spacer sleeve 19 is arranged in the direction of the axle housing 3 so that the two wheel bearings 5, 6, the spacer sleeve 19 and the wheel hub 2 together form the hollow space 12 for oil or grease.

Furthermore, a first shaft sealing ring 9a and a second shaft sealing ring lla are also provided. The first shaft sealing ring 9a is arranged radially between the first spacer ring 7 and the wheel hub 2, and the second shaft sealing ring 11a is arranged radially between the second spacer ring 8 and the wheel hub 2.

In this case, the first spacer ring 7 comprises a first (static) seal 20 and the second spacer ring 8 comprises a second (static) seal 21, both extending in the direction of the axle housing 3. The two spacer elements, in this case spacer rings 7, 8, thus each form a counter-running surface for a dynamic seal and are carriers of a static seal. In other words, the spacer rings 7, 8 are both spacer elements and seal carriers.

The hollow space 12 is formed by the spacer sleeve 19 arranged in the direction of the axle housing 3, the two wheel bearings 5, 6 and the wheel hub 2. It can be filled with grease, for example lubricating grease, or also with oil.

Moreover, again, the brake disk 17 is provided as well as the wheel rim contact surface 18, these being a distance A2 apart from one another where the distance A2 is smaller than the distance Al so that the assembly can therefore be used with axles designated T P, FF, FL, TN and R according to the prior art in North America. Here, the distance A2 corresponds to a distance specified in the SAE Standard J2475.

By way of different variants of the two spacer rings in the wheel head assemblies 1, la according to the invention, if necessary, the wheel head 13 can be adapted in a customer-specific manner. For example, the wheel head 13 can be displaced inward or outward.

### INDEXES

### Prior art

100 Wheel head assembly
101 Wheel head
102 Wheel hub
103 Axle housing
104 Flanged shaft
105 First wheel bearing
160 Second wheel bearing
107 Hollow space
108 Brake disk
D Rotation axis
Axial direction A
109 Wheel rim contact surface
110 Bearing unit
A1 Distance
1, 1a Wheel head assembly
2 Wheel hub
3 Axle housing
4 Flanged shaft
5 First wheel bearing
6 Second wheel bearing
7 First spacer ring
8 Second spacer ring
9, 9a First shaft sealing ring
10 Nut
11, 11a Second shaft sealing ring
12 Hollow space
13 Wheel head
14 First bearing unit end
15 Second bearing unit end
16 Compact bearing
17 Brake disk
18 Wheel rim contact surface
19 Sleeve
20 First (static) seal
21 Second (static) seal

1. A wheel head assembly (1, 1a) for a vehicle axle, the wheel head assembly (1, 1a) comprising:
an axle housing (3);
a wheel hub (2);
a bearing unit, wherein the bearing unit is arranged coaxially relative to an axial rotation axis, and wherein by means of the bearing unit the wheel hub (2) is fitted so that it can rotate relative to the axle housing (3), wherein the bearing unit comprises at least two wheel bearings (5, 6) an axial distance apart from one another, and wherein the bearing unit has, respectively, a first axial bearing unit end (14) and a second axial bearing unit end (15); and
a first spacer element and a second spacer element are arranged in the axial direction on the axle housing (3), wherein the first spacer element is arranged in the axial direction on the first bearing unit end (14) and the second spacer element is arranged in the axial direction on the second bearing unit end (15), and wherein a fastening element is provided for the axial fixing of the bearing unit by securing the first and second spacer elements with the bearing unit.

2. The wheel head assembly (1, 1a) according to claim 1, wherein a hollow space (12) is delimited by the two wheel bearings (5, 6) and the wheel hub (2).

3. The wheel head assembly (1, 1a) according to claim 1, wherein the fastening element is arranged in the axial direction on the axle housing (3).

4. The wheel head assembly (1, 1a) according to claim 1, wherein the two spacer elements and the bearing unit are located in a bore of the wheel hub (2).

5. The wheel head assembly (1, 1a) according to claim 4, wherein the fastening element comprises at least one nut (10) arranged with the two spacer elements and the bearing unit in the bore of the wheel hub (2).

6. The wheel head assembly (1, 1a) according to claim 1, wherein the first spacer element and the second spacer element are in the form of a first spacer ring (7) and a second spacer ring (8).

7. The wheel head assembly (1, 1a ) according to claim 6, wherein the second spacer ring (8) is arranged between the axle housing (3) and the bearing unit, and is fixed axially by the fastening element and the bearing unit and also the first spacer ring (7).

8. The wheel head assembly (1, 1a) according to claim 7, wherein the second spacer ring (8) is axially secured by the axial fastening element between the second bearing unit end (15) and the axle housing (3).

9. The wheel head assembly (1, 1a ) according to claim 1, comprising: a first sealing ring (9) and a second sealing ring (11) wherein the first sealing ring (9) is arranged radially between the first bearing unit end (14) and the wheel hub (3), and the second sealing ring (11) is arranged radially between the second bearing unit end (15) and the wheel hub (3).

10. The wheel head assembly (1, 1a) according to claim 1, wherein the bearing unit is in the form of a compact bearing (16).

11. The wheel head assembly (1, 1a) according to claim 1, comprising: a first sealing ring (9a ) and a second sealing ring (11a ) and the first sealing ring (9a ) is arranged radially between the first spacer element and the wheel hub (2), while the second sealing ring (11a ) is arranged radially between the second spacer element and the wheel hub (2).

12. The wheel head assembly (1, 1a) according to claim 11, wherein the first and second spacer elements each comprises a respective static seal (20, 21) facing toward the axle housing (3) for sealing the spacer elements relative to the axle housing 3).

13. The wheel head assembly (1, 1a ) according to claim 11, wherein the at least two wheel bearings (5, 6) are connected by means of a spacer sleeve (19).

14. The wheel head assembly (1, 1a) according to claim 13, wherein the spacer sleeve is arranged toward the axle housing (3) so that the two wheel bearings, the spacer sleeve, and the wheel hub (2) together form a hollow space (12).

15. The wheel head assembly (1, 1a ) according to claim 12, wherein the first and second spacer elements each has an axial spacer element width, the two spacer element widths being different.
